(19) United States
(12) Patent Application Publication
(10) Pub. No.: US 2003/0000588 A1
(43) Pub. Date: Jan. 2, 2003

(54) Pulsation dampener

(76) Inventors: Robert L. Kuykendal, High Ridge, MO (US); Ronald S. Deichmann, High Ridge, MO (US)

Correspondence Address: HENRY W. CUMMINGS, 3313 W. ADAMS ST., ST. CHARLES, MO, 63301, US

(21) Appl. No.: 10/101,989

(22) Filed: Mar. 21, 2002

Related U.S. Application Data
(63) Continuation-in-part of application No. 09/813,141, filed on Mar. 21, 2001, now abandoned.

(51) Int. Cl. F16L 55/04

(52) U.S. Cl. 138/26; 138/30

(57) ABSTRACT

This invention discloses an inlet rigid pipe with a large number of holes drilled laterally through its side wall with each hole being significantly smaller than the pipe internal diameter such that fluid made to flow into an end of the pipe will tend to flow out through the lateral holes at substantially equal flow rates. By spacing the holes along the length of the tube at some fractional multiple of P apart, then fluid flowing out from adjacent holes will concurrently exhibit different pressure variations which will tend to mutually cancel. For example, if two adjacent holes are space P/2 apart, then while fluid flowing from the first hole is exhibiting a periodic maximum pressure, the adjacent hole will concurrently be exhibiting a minimum. Actually, a random spacing of the holes is very effective as long as they are not spaced an integral multiple of P apart.

This application is a continuation-in-part of Ser. No. 09/813,141, filed Mar. 21, 2001.

### I. FIELD OF THE INVENTION

This invention discloses a method and apparatus for absorbing and smoothing the periodic pressure variations (pulsations or “pump noise”) associated with fluid flow from centrifugal or other types of fluid pumps, particularly those which use an impeller with individual impeller blades.

### II. BACKGROUND OF THE INVENTION

This invention discloses a method and apparatus for absorbing and smoothing the periodic pressure variations (pulsations or “pump noise”) associated with fluid flow from centrifugal or other types of fluid pumps, particularly those which use an impeller with individual impeller blades. For certain applications such as ornamental fountains and laminar flow nozzles, those minute pressure variations are particularly undesirable.

U.S. Pat. No. 5,160,086 discloses a lighted laminated flow nozzle for use in a decorative water fountain which includes a double walled bladder fluid supply hose for dampening pulsations prior to water entering the nozzle body.

U.S. Pat. No. 5,785,089 discloses a fluid flow nozzle assembly in which the inlet to the nozzle assembly includes an improve double walled bladder hose system in which fluid is made to flow in a parallel manner, first forwardly within the tube and then backwardly within the tube and forwardly again to dampen and isolate the nozzle assembly from pressure variations including pump noise. In one embodiment the dampening system is orientated horizontaly and in another embodiment the dampening system is orientated vertically.

### III. SUMMARY OF THE INVENTION

Given that fluid flow through a pipe has periodic pressure variations or pulsations which can be measured or calculated in terms of a linear distances between pulses as follows: Given: A pump with a flow rate of 70 gallons per hour, at 1750 revolutions per minute, an impeller with three blades and an outlet pipe of ½ inch diameter. What is the physical distance P along the outlet pipe, between each pulse?

1) Calculate the Flow rate in units of in. ³/sec.

$$\begin{matrix}Flow Rate = 70 gal . \text{/} hour \\ = ( 70 gal . \text{/} hour ) \times ( 1 hour \text{/} 3600 sec . ) \\ = 019 gal . \text{/} sec \\ = ( .019 gal . \text{/} sec . ) \times ( 1 ft . 3 \text{/} 7.487 gal . ) \times \\ ( 1728 in . 3 \text{/} ft {.}^{3} )\end{matrix}$$

2) Calculate the length, L, of a ½ in. ID pipe that is occupied by one cubic inch of fluid.

V=1 in.³

V cylinder=II×R²×L

R=¼ in.

V cylinder=II×(¼)²×L

1 in.³=II(×(¼)²×L

L=1/(II×¼))

L=6.093 in.

3) Calculate the Velocity in units of in./sec.

$$\begin{matrix}Velocity = 4.492 \text{in./sec} \\ = 4.492 \text{in./sec.} ) in ( \text{1/in} ) \times 5.093 in . \\ = 22.88 \text{in./sec}\end{matrix}$$

4) Calculate the Pulse Frequency or number of pulses per second at 1750 revolutions per minute and 3 blades per revolution.

$$\begin{matrix}3 blades \text{/} \text{rev.} Frequency = 8 pulses per revolution \\ = ( 1750 ev . \text{/} min . ) \times ( 1 min . \text{/} 60 sec . ) \times \\ 3 pulses \text{/} rev . ) \\ = 87.5 pulses \text{/} sec . \\ = 87.5 HZ\end{matrix}$$

5) Calculate the Wavelength, A.

$$Speed of sound in water at 60 F is 4814 ft . \text{/} sec . = 57 , 768 in . \text{/} sec . \\ \begin{matrix}A = distance between pulses ( Wavelength ) \\ = speed of sound / Frequency \\ = ( 57 , 768 in . \text{/} sec . / ( 87.5 HZ ) \\ = 660 inches\end{matrix}$$

From (5) we can see that a pulse wave length of 660 inches is much larger than most ordinary ornamental fountains and a pulse transmission sped of 4814 feet per second can be considered practically instantaneous in small ordinary ornamental fountains. Therefore:

6) We calculate the distance, p, in units of inches, that the water travels through the pipe between the generation of each pulse:

$$\begin{matrix}P = Velocity \times Time \\ = ( Water Flow Velocity ) \times ( Time Between Pulses ) \\ = ( 22.88 in . \text{/} sec . ) \times ( 1 / Pulse Frequency ) \\ = ( 22.88 in . \text{/} sec . ) \times ( 1 / 87.5 pulses \text{/} sec . ) \\ = ( 22.88 in . \text{/} sec . ) \times ( sec . / 87.5 ) \\ = .26 in .\end{matrix}$$

This invention discloses an inlet rigid pipe with a large number of holes drilled laterally through its side wall with each hold being significantly smaller than the pipe internal diameter such that fluid made to flow into an end of the pipe will tend to flow out through the lateral holes at substantially equal flow rates. By spacing the holes along the length of the tube at some fractional multiple of P apart, then fluid flowing out from adjacent holes will concurrently exhibit different pressure variations which will tend to mutually cancel. For example, if two adjacent holes are spaced P/2 apart then while fluid flowing from the first hole is exhibiting a periodic maximum pressure, the adjacent hole will concurrently be exhibiting a minimum. Actually, a random spacing of the holes is very effective, as long as they are not spaced an integral multiple of P apart.

### IV. THE DRAWINGS

FIG. 1 is a side elevation view of one embodiment of the present invention.

FIG. 2 is an orthagonal elevation view of the embodiment shown in FIG. 1.

FIG. 3 is a side elevation view of another embodiment of the present invention.

FIG. 4 is a side elevation view of another embodiment of the present invention.

FIG. 5 is a side elevation view of another embodiment of the present invention.

FIG. 6 is a side elevation view of another embodiment of the present invention.

FIG. 7 is a side elevation view of a one stage pulsation dampening system.

FIG. 8 is a side elevation view of a two stage pulsation dampening system.

FIG. 9 is a side elevation view of a three stage pulsation dampening system.

FIG. 9A is a plot of the pulsations occurring in FIG. 9, illustrating their sine wave relationship with time.

### V. DESCRIPTION OF PREFERRED EMBODIMENTS

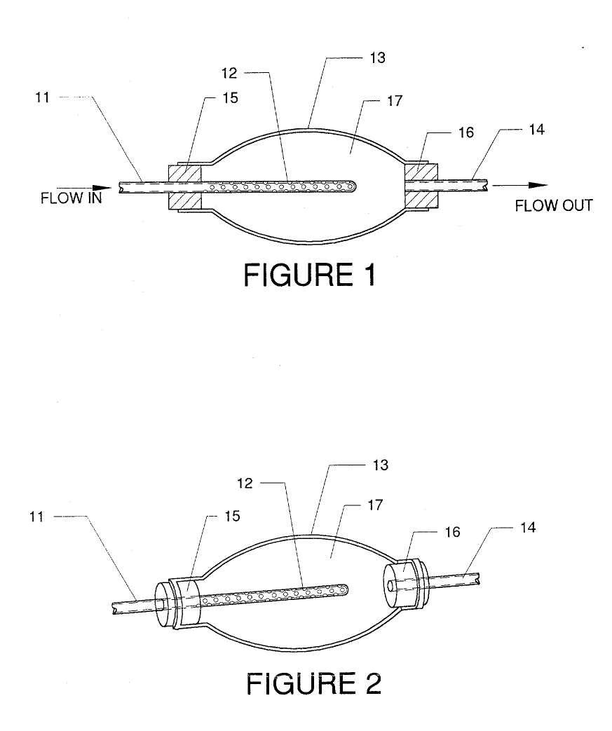

FIG. 1 shows an enclosed vessel, 17, with 1, an outlet pipe, 14, endcaps, 15 and 16, and side walls, 13, made of an elastic, bladder-like material. The inlet rigid pipe 11 is perforated with a large number of lateral holes, 12, all of which are substantially smaller than the internal diameter of pipe 11. In this example the pipe internal diameter is ½″ and the lateral holes are each ⅛″ diameter and there are 24 of them spaced at random along the length of the pipe, 11. Pressurized fluid made to flow in through the inlet pipe, 11, will tend to flow out through the various lateral holes, 12, at differing increments of their periodic pressure cycles and into the enclosed vessel, 17. Remaining slight pressure variations will also tend to be absorbed and smoothed by expansion and contraction of the bladder-like sidewall, 13. Fluid then flowing out from the enclosed vessel, 17, through outlet pipe, 14, will be substantially free of slight pressure variations or “pump noise”. FIG. 2 shows an orthogonal view of the described device.

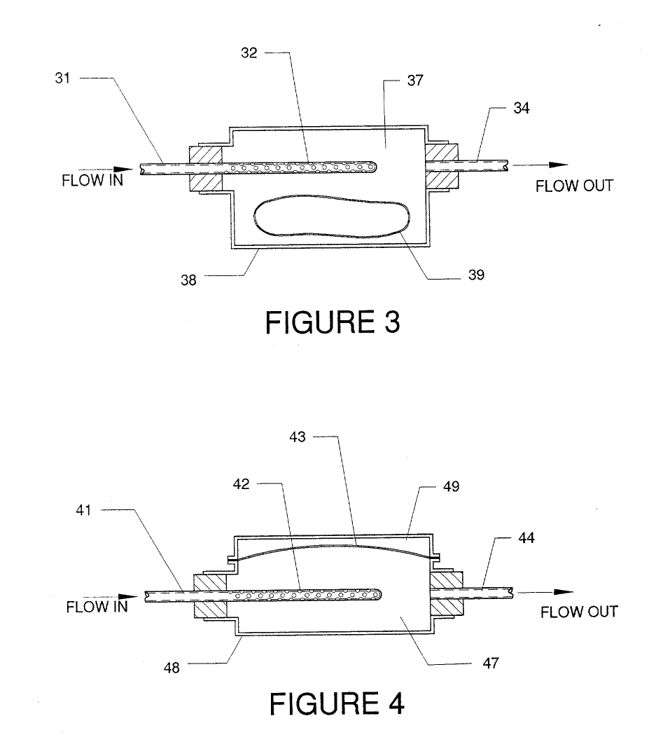

Another embodiment of the invention shown in FIG. 3 comprises a substantially rigid inlet pipe which is perforated with a large number of lateral holes, 32, an outlet pipe, 34, and an enclosed vessel, 38. Within the enclosed vessel, 38, is a balloon-like, gas filled chamber, 39, which functions like the bladder-like sidewalls, 13, of FIG. 1 to expand and contract to absorb minute pressure pulsations.

Another embodiment of the invention shown in FIG. 4 comprises a substantially rigid inlet pipe, 41, which is perforated with a large number of lateral holes, 42, an outlet pipe, 44, and an enclosed, substantially rigid chambered vessel, 48. In this embodiment said chambered vessel, 48, comprises a fluid chamber, 47, and a gas chamber, 49, separated by an elastic, bladder-like membrane, 43. In this embodiment, pulsations remaining after the fluid has entered through the inlet port, 41, and flown through the lateral holes, 42, will tend to be absorbed by expansion and contraction of the bladder-like membrane, 43, and the consequent compression and expansion of the enclosed gas chamber, 49.

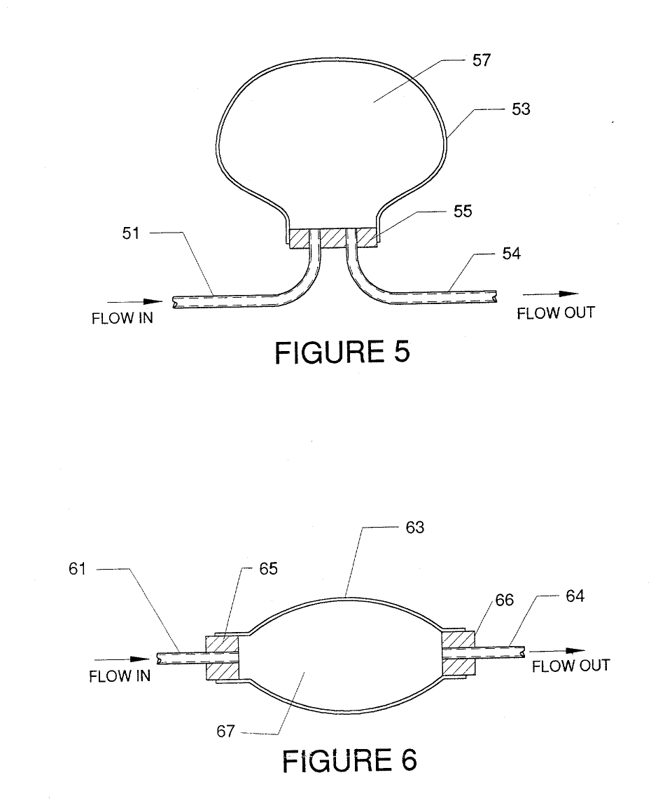

Another embodiment of the invention, shown in FIG. 5, comprises a substantially rigid inlet pipe 51, an enclosed chamber 57, surrounded by an elastic, bladder-like enclosure 53, with an outlet pipe 54, and an end cap 55. In this embodiment pulsations tend to be absorbed by expansion and contraction of the bladder-like enclosure 53. Another embodiment of the invention, shown in FIG. 6, comprises a substantially rigid inlet pipe 61, projecting through an end cap 65, into a chamber 67, with an outlet pipe 64, projecting through a second end cap 66. Said chamber is enclosed by a bladder-like membrance, 63. Pressurized fluid that is made to pass through inlet pipe 61, contains pulsations which tend to be absorbed by the expansion and contraction of the bladder-like membrane 63. The fluid then flows out through outlet pipe 64, with the pulsations substantially reduced.

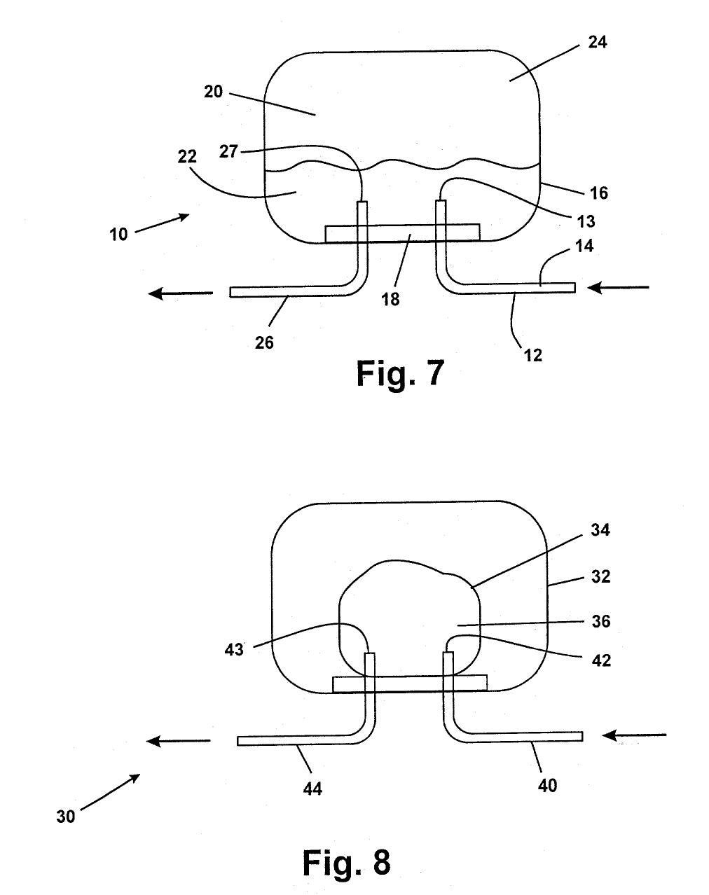

In FIG. 7 in another embodiment indicated generally at 10, a conduit 12 supplies a fluid 14 into a rigid enclosure 16. The conduit 14 extends through a base 18 and fluid flows into a chamber 20 which includes water in a lower portion 22 and air in the upper portion 24 of the chamber.

The air cushions the fluid as it passes into the chamber 30. As the fluid exits through the conduit 26 pulsations and pressure variations have been reduced or eliminated by the dampening of the air/water system in chamber 20. Conduit 12 includes an inlet opening 14 into the chamber and conduit 26 includes an in let 27 into the conduit 26 for the fluid to exit.

In another embodiment 30 shown in FIG. 8 a rigid enclosure 32 houses a bladder 34 containing water 36. An inlet conduit 40 carries fluid to be dampened and has an inlet opening 42 into bladder 34 containing water 30. An outlet conduit 44 is provided having an inlet 43 from the bladder 34. Pulsations are reduced within the bladder 34 by the combined action of the fluid entering the water and the water in turn acting on the air. This causes a double stage of pulsation reduction or elimination to occur in this arrangement.

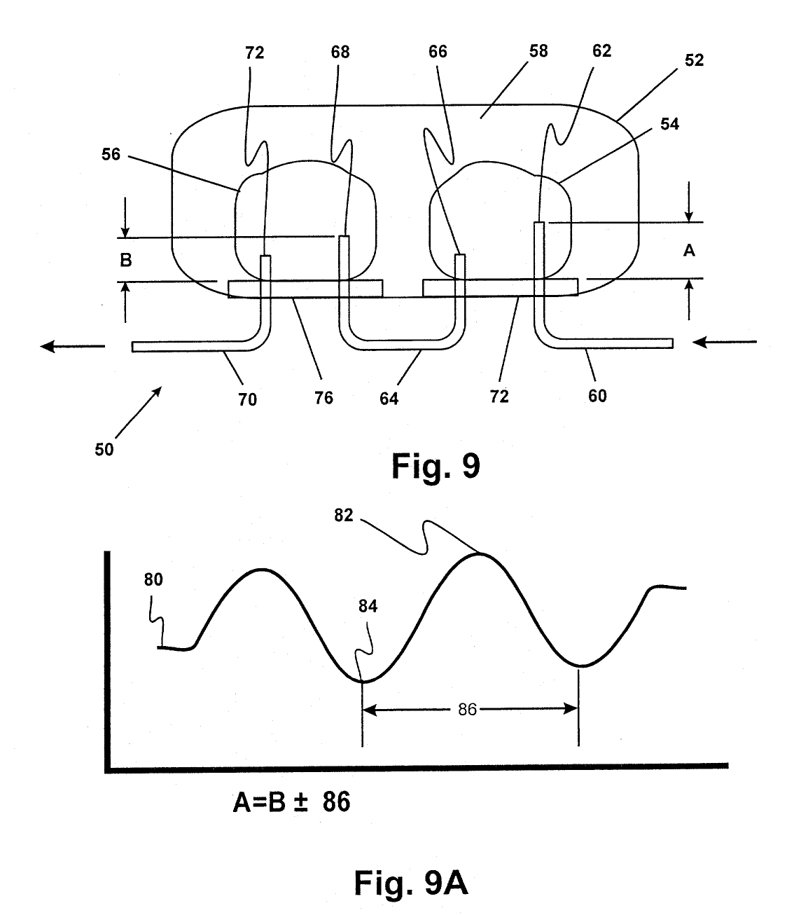

In FIG. 9 in a three stage embodiment 50 a rigid container 52 includes a first bladder 54 and second bladder 56. The rigid enclosure 52 includes air the chamber 58 and water is provided in the bladders 54 and 56. An inlet conduit for fluid 60 includes an opening 62 into bladder 54 and another conduit 64 includes an opening 66 in bladder 54 and includes another opening 68 in bladder 56 to transfer fluid between the bladders 54 and 56. Another conduit 70 includes an opening 72 in bladder 56 to transfer the fluid to the next stage or into a fountain assembly. Conduit 60 extends above base 72 a distance 74 a distance A and conduit 64 extends above base 76 a distance B. As shown in FIG. 9A the pulsations entering through conduit 60 are generally of a sinusoidal form as indicated at 80 having an apex 82 and a bottom of the signwave 84. The length of one signwave unit

What is claimed is:

1. At fluid pressure pulsation absorbing device comprising an enclosed vessel with at least one elastic, bladder-like wall with at least one inlet port and at least one outlet port.

2. A fluid pressure pulsation absorbing device comprising an enclosed vessel with at least one inlet port and at least one or more outlet port, said vessel containing therein a balloon-like, gas filled chamber.

3. A fluid pressure pulsation absorbing device comprising an enclosed vessel with at least one elastic, bladder-like wall, at least one inlet port and at least one outlet port, said inlet port comprising a rigid tube perforated with a plurality of lateral holes space at other than P distance apart.

4. A pulsation dampening system according to claim 3 including a rigid enclosure containing a liquid occupying a portion only of the volume in said rigid enclosure;
first conduit means for introducing a fluid containing pulsations extending into the rigid enclosure within the liquid contained therein;
second conduit means also extending into said rigid enclosure within the liquid portion and adopted to transfer fluid which has been cushioned within said rigid enclosure to a subsequent destination; whereby fluid conveyed into said rigid enclosure by said first conduit means is cushioned by the liquid displacing air within the rigid enclosure and whereby fluid so cushioned is adopted to exit said rigid enclosure after pulsations have been dampened within said rigid enclosure.

5. A pulsation dampening system according to claim 3 including rigid enclosure, a bladder mounted within said rigid enclosure and comprising a liquid within said bladder; first conduit means for conveying a fluid containing pulsations for transferring said fluid into said bladder whereby said fluid will displace water within said bladder and said bladder will displace air within said rigid container to reduce or eliminate pulsations within the fluid; and
second conduit means for removing said fluid from said bladder and transferring said fluid to another destination after pulsation's have been reduced or eliminated within said rigid container and said bladder.

6. A pulsation dampening system according to claim 3 including a rigid enclosure; a first bladder located within said rigid enclosure adopted to contain a liquid; a second bladder located within said rigid enclosure also adopted to contain a liquid; first conduit means for conveying a fluid containing pulsation's into first bladder; second conduit means for transferring said fluid from said first bladder to said second bladder;
third conduit means for transferring fluid from said second bladder to an external destination whereby fluid in said first bladder is cushioned by said fluid displacing liquid in said first bladder, and said liquid further displacing air located in said rigid enclosure, and whereby fluid conveyed to said second bladder is cushioned by the fluid acting upon the water within said second bladder and water acting upon the air within said rigid enclosure; whereby pulsation's are dampened both within said first bladder and within said second bladder and pulsations are reduced or eliminated within the fluid conveyed into said first and second bladder; and third conduit means for transferring said fluid to a different destination from said second bladder.

7. Apparatus according to claim 6 wherein said first conduit means extends into said first bladder a distance D1 and wherein said second conduit means extends into said second bladder a distance D₂ and wherein the distance D1 exceeds the distance D2 by at least one sinewave length.

8. A fluid pressure pulsation absorbing device according to claim 3 wherein by spacing the holes along the length of the tube at some fractional multiple of P apart, whereby the fluid flowing out from adjacent holes will concurrently exhibit different pressure variations which will tend to mutually cancel.

9. A fluid pressure pulsation absorbing device according to claim 3, wherein two adjacent holes are spaced P/2 apart while fluid flowing from the first hole is exhibiting a periodic maximum pressure, the adjacent hole will concurrently be exhibiting a minimum.

10. A fluid pressure pulsation absorbing device according to claim 3, wherein a random spacing of the holes is provided that are not spaced an integral multiple of P apart.
